(19) United States
(12) Patent Application Publication
(10) Pub. No.: US 2004/0114617 A1
(43) Pub. Date: Jun. 17, 2004

(54) Apparatus and method for Weighted Round-Robin cell scheduling for Asynchronous Transfer Mode

(76) Inventors: Jae-Cheol Sim, Daejeon (KR); Man-Soo Han, Daejeon (KR); Sang-Taick Park, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/606,444

(22) Filed: Jun. 26, 2003

(30) Foreign Application Priority Data
Nov. 21, 2002 (KR) 2002-72643

(51) Int. Cl. H04L 12/28

(52) U.S. Cl. 370/413

(57) ABSTRACT

An apparatus of WRR (Weighted Round-Robin) cell scheduling for ATM comprises: a virtual connection queues for storing the cells of virtual connection having a weight given by a natural number N; scheduling weight queues having a weight given by a power of 2 for servicing the virtual connection by as much as its weight N; a scheduling weight queue controller for selecting the scheduling weight queues for the virtual connection queue and register the virtual connection queue in the selected scheduling weight queues; and a queue selector for selecting the scheduling weight queues.

### BACKGROUND OF THE INVENTION

(a) Field of the Invention

The present invention relates to a cell scheduler in ATM (Asynchronous Transfer Mode) systems. More specifically, the present invention relates to an apparatus and method for WRR (Weighted Round-Robin) cell scheduling for ATM that allows simple implementation and high-speed processing with less hardware resources in adopting a WRR scheduler.

(b) Description of the Related Art

In ATM systems, data are transmitted in cell units having a fixed length, said cells being discriminated from one another with identifiers, such as VPI (Virtual Path Identification) and VCI (Virtual Channel Identification), provided in the header.

Particularly, cells having the same VPI and VCE are supposed to belong to a same VC (Virtual Connection), and each connection has requirements including a bandwidth and a processing characteristic, commonly called “traffic parameters.” In ATM systems, multiple connections are serviced simultaneously and supposed to satisfy the service quality which is represented in the traffic parameters.

The traffic parameters are classified, according to their characteristics, into classes of CBR (Constant Bit Rate), VBR (Variable Bit Rate), and UBR (Undefined Bit Rate). As for connections belonging to UBR class and connections are serviced without any definite bandwidth requirement. If a guarantee of MCR (Minimum Cell Rate) is required, the individual connections have to be serviced with a bandwidth proportional to the MCR.

For processing conforming to the traffic parameters, the ATM systems realize a traffic scheduler, of which the important function is providing services for connections impartially based on their traffic parameters in the case of congestion.

Particularly, the traffic scheduler generally employs the WRR algorithm for processing connections having the UBR characteristic. The WRR algorithm is for guaranteeing fairness to the connections in conformity to the assigned weight to the individual connections and providing services in proportion to the weight.

The above-stated WRR scheduling is disclosed in U.S. Pat. No. 6,032,218 under the title of “Configurable Weighted Round Robin Arbiter.”

The patent relates to an embodiment of a WRR scheduler, especially, an embodiment of switches, and proposes a method of using a scheduler circuit with an eligibility register and a weight table.

The method is, however, focusing on the embodiment of switches and has a problem in regard to complicated construction for scheduling large number of items.

Concerning the WRR scheduler, U.S. Pat. No. 6,330,223B1 under the title of “Weighted Round-Robin Multiplexing of ATM Cells by Updating Weights with Counter Outputs” suggests cell scheduling for ATM in which a weight is assigned by service classes.

The patent proposes a method for service bandwidth according to the assigned weight by the service classes using counters, an adder, a comparator, and a controller circuit.

But this method has a problem in that amount of hardware resources are increased linearly as the number of the service classes increases.

### SUMMARY OF THE INVENTION

It is accordingly an advantage of the present invention to provide an apparatus and method for WRR cell scheduling for ATM in which a WRR scheduler supports different weights in ATM systems and has a simple construction in hardware, thereby using a smallest number of memories for the operation concerned.

In one aspect of the present invention, there is provided an apparatus of WRR (Weighted Round-Robin) cell scheduling for ATM (Asynchronous Transfer Mode), said apparatus being for servicing virtual connections fairly according to a weight of each virtual connection in an ATM system servicing a plurality of virtual connections having a weight based on the required service quality, the apparatus including: virtual connection queues for temporarily storing cells of virtual connection having a weight given by a natural number N; a plurality of scheduling weight queues having a weight given by a power of 2; a scheduling weight queue controller for controlling the virtual connection queue to select the scheduling weight queues having a weight given by a power of 2 and register the virtual connection queue in the selected scheduling weight queues; and a queue selector for selecting the scheduling weight queues in the order of high to low weight.

Preferably, the apparatus further includes: a mask bitmap including a plurality of mask bits assigned to the individual scheduling weight queues, whereby the queue selector does not reselect the scheduling weight queues previously selected by as many as its weight; and a scheduling counter for updating the mask bitmap.

Preferably, the values of the mask bitmap are all cleared during initialization of the system or the scheduling counter and when the value of the scheduling counter increases from 2ⁱ−1 to 2ⁱ, a mask bit corresponding to the scheduling weight queue having a weight of 2ⁱ⁻¹ is set to 1.

Preferably, the scheduling counter is initialized to “1” during initialization of the system, the scheduling counter performing a counting operation when the queue selector cannot find a scheduling weight queue having a highest weight with the mask bit not being set to “1”, and the scheduling counter being initialized when the queue selector cannot find any scheduling queue to be selected and when the scheduling weight queues with the mask bit cleared are all empty.

Preferably, the scheduling weight queue stores information of the virtual connection queue.

Preferably, the queue selector selects a scheduling weight queue that is not empty and that has the mask bit cleared and that its weight is the highest one among the weights that is lower than the weight of previously selected scheduling weight queue.

Preferably, the scheduling weight queue controller registers the virtual connection queue in the scheduling weight queue when the virtual connection queue has a new input cell, or when the virtual connection queue still has a cell to be serviced after one cell is serviced by selection of the scheduling weight queue including the corresponding virtual connection queue.

Preferably, when the weight N of the corresponding virtual connection queue is expressed as a series of addition of powers of 2, the scheduling weight queue controller registers the virtual connection queue in a scheduling weight queue having a weight which is equal to one term of the series and the highest but lower than the weight of a scheduling weight queue currently selected by the queue selector. If these conditions are not satisfied, then the scheduling weight queue controller registers the virtual connection queue in a scheduling weight queue having a weight corresponding to the highest term in the above-stated series.

In another aspect of the present invention, there is provided a method of WRR cell scheduling for ATM that includes: (a) temporarily storing a plurality of virtual connection cells waiting for being serviced in a virtual connection queue; (b) separating the weight of the virtual connection queue in the form of additions of powers of 2; (c) registering the corresponding virtual connection in a plurality of scheduling weight queues having the weight corresponding to the individual terms of powers of 2; and (d) selecting the scheduling weight queues having virtual connection to be serviced, in the order of high to low weight, thereby servicing the cell of the corresponding scheduling weight queue.

Preferably, the method further includes, after sequentially servicing the scheduling weight queues in the order of high-to-low weight in the step (d), determining whether the scheduling weight queue has a virtual connection to be serviced, in the order of high to low weight, and then selecting the scheduling weight queues having a virtual connection to be serviced.

Preferably, the method further includes setting the mask bit to “1” so as not to select the scheduling weight queues previously serviced as many as the weights of them and clearing all mask bits so as to rehabilitate the scheduling weight queues when there is no unmasked scheduling weight queue.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic block diagram of a WRR cell scheduling apparatus for ATM according to an embodiment of the present invention;

FIG. 2 is a diagram showing the result of the operation of FIG. 1; and

FIG. 3 is a conceptual diagram of a WRR cell scheduling method for ATM according to the embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

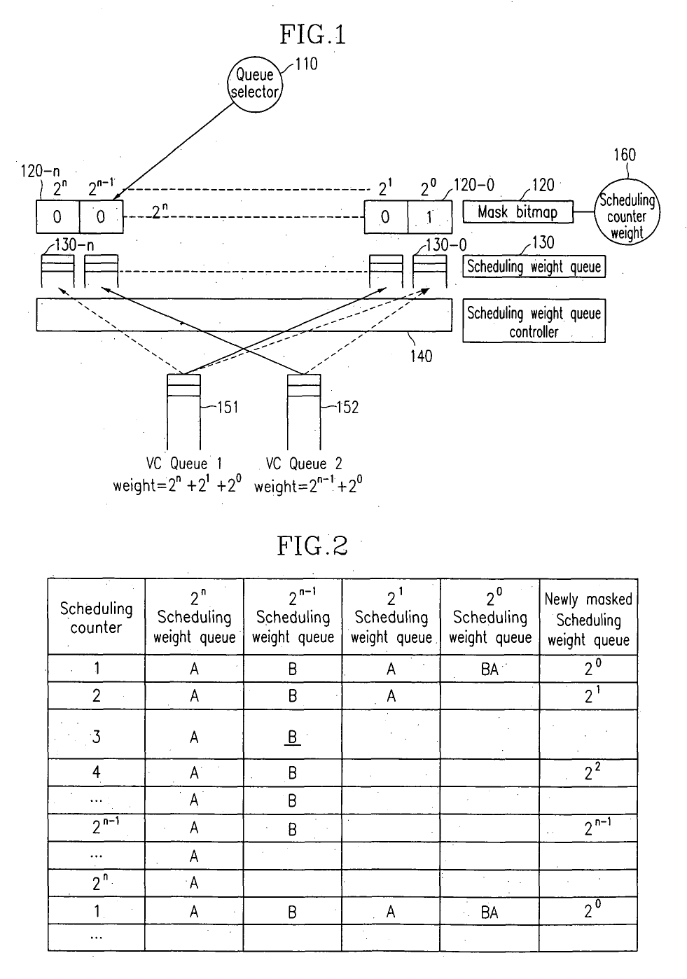

FIG. 1 is a schematic block diagram of a WRR cell scheduling apparatus for ATM according to an embodiment of the present invention.

Referring to FIG. 1, the WRR cell scheduling apparatus comprises a queue selector 110, a mask bitmap 120-0 to 120-n, a scheduling weight queue 130-0 to 130-n, a scheduling weight queue controller 140, a VC queue 1 151, a VC queue 2 152, and a scheduling counter 160. Although there are two VC queues in the description of the embodiment of the present invention, as many VC queues can be provided as there are connections.

In the WRR cell scheduling apparatus, the queue selector 110 selects one of the scheduling weight queues 130-0˜n having the highest weight among the weights that is lower than that of the previously selected queue and its corresponding mask bitmap 120 is not “1.”

The mask bitmap 120 limits the selection by the queue selector 110 for the scheduling weight queues 130-0˜n. Namely, the mask bitmaps 120-0 to 120-n are all cleared to “zero” when the system is initialized, or when the scheduling weight queues 130-0 to 130-n are all empty. Once the specific scheduling weight queue 130-0˜n is serviced as many as its weight, then the mask bit of the corresponding scheduling weight queue 130-0˜n is set to “1” so as the queue selector 110 not to select the corresponding scheduling weight queue 130-0˜n.

The scheduling weight queue 130-0˜n has a weight given by a power of 2.

In the WRR cell scheduling apparatus of FIG. 1, the scheduling weight queue controller 140 causes the VC queue 1 151 and the VC queue 2 152 having a weight given by a natural number to properly registered in a series of scheduling weight queues having a weight given by a power of 2.

The scheduling counter 160 is used for updating the mask bitmap 120. During initialization of the system, or when the mask bitmaps 120-0 to 120-n are all cleared to “zero”, the value of the scheduling counter 160 is initialized to “1” and then increased by one whenever there is no scheduling weight queue 130-0˜n satisfying a queue selection criterion.

Namely, the value of the scheduling counter 160 increases when there is no scheduling weight queue 130-0˜n having a lower weight than that of the current scheduling weight queue 130 and having connection registered, with the corresponding mask bit 120-0˜n not being “1.”

If there is no scheduling weight queue 130-0 to 130-n satisfying the queue selection criterion and the scheduling weight queues 130-0 to 130-n with the mask bitmap 120 not being set are all empty, then the scheduling counter 160 is reset to “1” and the mask bitmap 120-0 to 120-n is cleared to all “zero.”

If the value of the scheduling counter 160 increases to cause a carry, i.e., changes from 2ⁱ−1 to 2ⁱ, then the mask bit i-1 120-i-1 corresponding to the scheduling weight queue i-1 130-i-1 having a weight of 2ⁱ⁻¹ is set to “1.”

The WRR cell scheduling apparatus according to the embodiment of the present invention as constructed above provides n+1 scheduling weight queues 130-0 to 130-n having a weight given by a power of 2, and realizes the queue selector 110 designed to select a 2^{k}-weight queue 2^{k} times more frequently than a 2⁰-weight queue.

The weight of each connection is not specifically limited to a power of 2, and it may be any natural number. If the connection has a weight given by a natural number, then the scheduling weight queue controller 140 controls the virtual connection queue properly switched between scheduling weight queues having a weight of 2^{k}, thereby connections are serviced according to their weights represented in any natural number.

FIG. 1 shows the snapshot that the queue selector 110 selects the scheduling weight queue 130-n-1 having a weight of 2ⁿ⁻¹ after a selection of the scheduling weight queue 130-n having a weight of 2ⁿ.

In the figure, the solid arrows between the virtual connection queues(151, 152) and the scheduling weight queues(130-1˜n) represent that the virtual connection queues are registered in the pointed scheduling weight queue(130-1˜n) and the dotted arrows point the potential scheduling weight queues(130-1˜n) in which the virtual connections(151, 152) can be registered afterward.

Currently, the VC queue 1 151 is registered in the scheduling weight queue n 130-n and then in the scheduling weight queue 1 130-1 having the second highest weight among the candidates. The VC queue 2 152 is registered in the scheduling weight queue n-1 130-n-1.

When the queue selector 110 previously selects the scheduling weight queue n 130-n having a weight of 2ⁿ and then the scheduling weight queue n-1 (130-n) having the second highest weight, the VC queue 1 151 previously serviced in the scheduling weight queue n and then the VC queue 2 152 is serviced from the newly selected scheduling weight queue n-1.

Once the VC queue 2 152 is serviced in the scheduling weight queue n-1, the queue selector 110 selects, according to a queue selection algorithm, the scheduling weight queue 1 130-1 in which a connection to be serviced is registered and the mask bitmap is not set, thereby allowing the VC queue 1 151 to be serviced.

If there is a cell to be serviced after being serviced in the scheduling weight queue 130-1 once, then the VC queues 151 and 152 are registered in one of candidates 130-0 to 130-n again and are ready for the next service.

The result of the above-stated operation can be described as follows.

FIG. 2 shows the result of the operation of FIG. 1.

Referring to FIG. 2, when servicing VC queue 1 151 and VC queue 2 152 from the initial state of the system, the number of masked scheduling weight queues 130 increases with an increase in the value of the scheduling counter. Finally, only the scheduling weight queue 130-n having the highest weight is serviced.

When the value of the scheduling counter reaches 2ⁿ, the scheduling counter is reset to “1” and the mask bitmap is cleared, and then value of the scheduling counter is increased to 2ⁿ. This procedure is repeatedly performed.

Now, a description will be given in detail as to the concept of the WRR cell scheduling method according to the embodiment of the present invention.

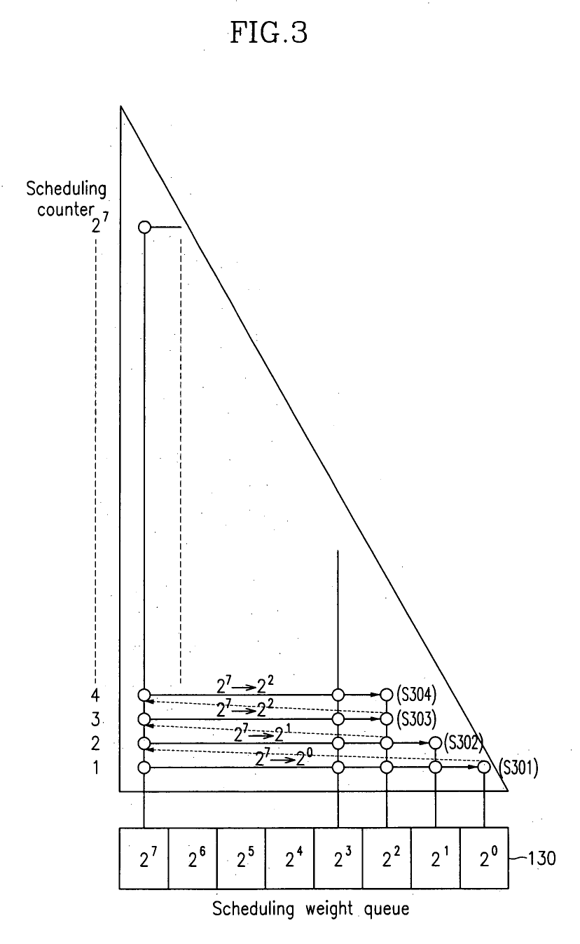

FIG. 3 is a conceptual diagram of a WRR cell scheduling method for ATM according to the embodiment of the present invention.

Referring to FIG. 3, for the purpose of illustration, scheduling weight queues having a weight of 2⁰ to 2⁷ are selected. If every scheduling weight queue has connections to be serviced, scheduling weight queues are selected and serviced in decreasing order of their weights, 2⁷ to 2⁰, in step S301

The scheduling weight queue having a weight of 2⁰ is previously serviced once in the first cycle S301 and is excluded in the second cycle, so that the scheduling weight queues having a weight of 2⁷ to 2¹ are serviced in the second cycle, in step S302.

Because the scheduling weight queues having a weight of 2¹ to 2⁰ are previously serviced as many as their weight, the scheduling weight queues having a weight of 2⁷ to 2² are serviced in the third and fourth cycles, in steps S303 and S304.

These steps are repeatedly performed until the scheduling weight queue having a weight of 2⁷ is serviced as many as its weight and this whole procedure is repeatedly performed.

The frequency of servicing each scheduling weight queue is equal to the weight value of a corresponding scheduling weight queue, and therefore the individual queues can be serviced 2^{k} times more frequently than the queue having a weight of 2⁰. As illustrated in FIG. 1, each VC queue is switched between the scheduling weight queues having a weight of 2^{k}, and consequently, they are serviced as frequently as the weight value being a natural number as expressed by the sum of weights being a power of 2.

In scheduling virtual connections in ATM systems, as described above, the apparatus and method of WRR cell scheduling for ATM performs scheduling not in the units of connection but in the units of scheduling weight queue representing a group of connections having the same weight term given by a power of 2, and does not count the number of being serviced for each connection so as to eliminate a need for memories or other special components such as an adder, a subtracter, or a comparator for updating the stored data amount, thereby simplifying the WRR scheduling apparatus.

Furthermore, the present invention assigns any weight value to the individual virtual connections and allows high-speed processing with a simple hardware construction.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus of WRR (Weighted Round-Robin) cell scheduling for ATM (Asynchronous Transfer Mode), said apparatus being for servicing connections fairly according to the weight of each virtual connection in an ATM system including a plurality of virtual connections having a weight based on a requirement for service quality, the apparatus comprising:
virtual connection queues for temporarily storing a plurality of cells of each virtual connection having a weight given by a natural number N;
a plurality of scheduling weight queues having a weight given by a power of 2;
a scheduling weight queue controller for controlling the virtual connection queue to select one of the scheduling weight queues having a weight given by a power of 2 and register the virtual connection queue in the selected scheduling weight queues; and
a queue selector for selecting the scheduling weight queues in the order of high to low weight.

2. The apparatus as claimed in claim 1, further comprising:
a mask bitmap including a plurality of mask bits assigned to the individual scheduling weight queues, whereby the queue selector does not reselect the scheduling weight queue previously selected by as many as its weight; and
a scheduling counter for updating the mask bitmap.

3. The apparatus as claimed in claim 2, wherein the values of the mask bitmap are all cleared during initialization of the system or the scheduling counter, and
when the value of the scheduling counter increases from 2ⁱ−1 to 2ⁱ, a mask bit corresponding to the scheduling weight queue having a weight of 2ⁱ⁻¹ is set to 1.

4. The apparatus as claimed in claim 2, wherein the scheduling counter is initialized to “1” during the initialization of the system,
the scheduling counter performing a counting operation when there is no non-empty scheduling weight queue having a highest weight with the mask bit not being set to “1”, and
the scheduling counter being reinitialized when the queue selector cannot find any scheduling weight queue to be selected and when the scheduling weight queues with the mask bit cleared are all empty.

5. The apparatus as claimed in claim 1, wherein the scheduling weight queue stores information of the virtual connection queue.

6. The apparatus as claimed in claim 1, wherein the queue selector selects a scheduling weight queue that is not empty and that has the mask bit cleared and that has a weight being the highest one of the weights, if any, that is lower than the weight of the previously selected scheduling weight queue.

7. The apparatus as claimed in claim 1, wherein the scheduling weight queue controller registers the virtual connection queue in the scheduling weight queue, when the virtual connection queue has a new input cell, or when the virtual connection queue still has a cell to be serviced after one cell is serviced by selection of the scheduling weight queue including the corresponding virtual connection queue.

8. The apparatus as claimed in claim 7, wherein when the weight N of the corresponding virtual connection queue is expressed as a series of addition of powers of 2, the scheduling weight queue controller registers the virtual connection queue in a scheduling weight queue having a weight equal to one term in the series of the virtual connection queue and the highest but lower than the weight of a scheduling weight queue currently selected by the queue selector,
and if these conditions are not satisfied, the scheduling weight queue controller registers the virtual connection queue in a scheduling weight queue having a weight corresponding to the highest term among the powers of 2 expressing the weight of the corresponding virtual connection queue.

9. A method of WRR cell scheduling for ATM, comprising:
(a) temporarily storing a plurality of virtual connection cells in a virtual connection queue having a weight for being serviced;
(b) separating the weight of the virtual connection queue in the form of additions of powers of 2;
(c) registering the corresponding virtual connection in a plurality of scheduling weight queues having the weight corresponding to the individual terms of a power of 2; and
(d) selecting the scheduling weight queues having virtual connection to be serviced, in the order of high to low weight, thereby servicing the virtual connection of the corresponding scheduling weight queue.

10. The method as claimed in claim 9, further comprising:
after sequentially servicing the scheduling weight queues in the order of high-to-low weight in (d),
determining whether the scheduling weight queue has a virtual connection to be serviced, in the order of high to low weight, and then selecting a scheduling weight queue having a virtual connection to be serviced.

11. The method as claimed in claim 10, further comprising:
forbidding to select the scheduling weight queues previously selected by as many as the weight of the scheduling weight queue, when the scheduling weight queues are selected.

12. The method as claimed in claim 11, further comprising:
rehabilitating all scheduling weight queues, when there is no scheduling weight queue which is not forbidden.
